(19) United States
(12) Patent Application Publication
(10) Pub. No.: US 2012/0147015 A1
(43) Pub. Date: Jun. 14, 2012

(54) Graphics Processing in a Multi-Processor Computing System

(75) Inventors: Philip J. Rogers, Pepperell, MA (US); David A. Gotwalt, Winter Springs, FL (US)

(73) Assignee: Advanced Micro Devices, Inc., Sunnyvale, CA (US)

(21) Appl. No.: 13/324,698

(22) Filed: Dec. 13, 2011

Related U.S. Application Data
(60) Provisional application No. 61/422,327, filed on Dec. 13, 2010.

(51) Int. Cl. G06F 15/16

(52) U.S. Cl. 345/502

(57) ABSTRACT

A method, computer program product, and computing system are provided for processing a graphics operation. For instance, the method can include receiving the graphics operation from an application. The method can also include allocating a first portion of the graphics operation to a first processing unit and a second portion of the graphics operation to a second processing unit. This allocation between the first and second processing units can be based on at least one of a performance profile and a functionality profile of the first and second processing units.

### CROSS REFERENCE TO RELATED APPLICATION

This application claims the benefit of U.S. Provisional Application No. 61/422,327 (SKGF Ref. No. 1972.1140000), filed Dec. 13, 2010, titled “Graphics Processing in a Multi-Processor Computing System,” which is incorporated by reference herein in its entirety.

### BACKGROUND

1. Field

Embodiments of the present invention generally relate to graphics processing in a multi-processor computing system.

2. Background

Graphics and video processing hardware and software continue to become more advanced each year. Graphics and video processing circuitry is typically present on add-on cards in a computer system, but can also be found on the motherboard itself. The graphics processor is responsible for creating graphics displayed by a monitor of the computer system. In early text-based personal computers, the display of graphics on a monitor was a relatively simple task. However, as the complexity of modern graphics-capable operating systems has dramatically increased due to the amount of information to be displayed, it is now impractical for graphics processing to be handled by the general purpose portion of the main processor or central processing unit of the computer system. As a result, the display of graphics is now handled by increasingly-intelligent graphics cards, which include specialized co-processors or logic referred to as graphics processing units (GPUs) or video processing units (VPUs). This combination of processing units in a computer system is oftentimes referred to as a “multi-processor computing system.”

In multi-processor computing systems, an imbalance in performance and function may exist between the computing devices in the computing system. For instance, in the processing of graphics data, an imbalance in computing bandwidth between a CPU and a GPU in the multi-processor computing system may result in a mismatch in processing time of graphics data frames. This mismatch in processing time of graphics data frames can lead to a poor viewing experience.

Methods and systems are needed to process computing operations, such as graphics operations, in multi-processor computing systems.

### SUMMARY OF EMBODIMENTS

Embodiments of the present invention include a method for processing a graphics operation. The method can include receiving the graphics operation from an application such as, for example and without limitation, a video game. In addition, the method can include allocating a first portion of the graphics operation to a first processing unit and a second portion of the graphics operation to a second processing unit based on at least one of a performance profile and a functionality profile of each of the first and second processing units. Each of the first and second processing units can be a central processing unit (CPU), a graphics processing unit (GPU), an application-specific integrated circuit (ASIC) controller, other similar types of processing units, or a combination thereof.

Embodiments of the present invention additionally include a computer-usable medium having computer program logic recorded thereon that, when executed by one or more processors, processes a graphics operation. The computer program logic can include a first computer readable program code that enables a processor to receive the graphics operation from an application. In addition, the computer program logic can include a second computer readable program code that enables a processor to allocate a first portion of the graphics operation to a first processing unit and a second portion of the graphics operation to a second processing unit based on at least one of a performance profile and a functionality profile of each of the first and second processing units.

Embodiments of the present invention further include a computing system. The computing system can include an application module, an application programming interface (API), a first processing unit, a second processing unit, a driver module, and a display module. The driver module can be configured to receive a graphics operation from the API. The driver module can also be configured to allocate a first portion of the graphics operation to the first processing unit and a second portion of the graphics operation to the second processing unit based on at least one of a performance profile and a functionality profile of each of the first and second processing units.

Further features and advantages of the invention, as well as the structure and operation of various embodiments of the present invention, are described in detail below with reference to the accompanying drawings. It is noted that the invention is not limited to the specific embodiments described herein. Such embodiments are presented herein for illustrative purposes only. Additional embodiments will be apparent to persons skilled in the relevant art based on the teachings contained herein.

### BRIEF DESCRIPTION OF THE DRAWINGS

The accompanying drawings, which are incorporated herein and form a part of the specification, illustrate embodiments of the present invention and, together with the description, further serve to explain the principles of the invention and to enable a person skilled in the relevant art to make and use the invention.

FIG. 1 is an illustration of a multi-processor computing system in which embodiments of the present invention can be implemented.

FIG. 2 is an illustration of another multi-processor computing system in which embodiments of the present invention can be implemented.

FIG. 3 is an illustration of an embodiment of a method for processing a graphics operation.

FIG. 4 is an illustration of another embodiment of a method for processing a graphics operation.

FIG. 5 is an illustration of an example computer system in which embodiments of the present invention can be implemented.

### DETAILED DESCRIPTION

The following detailed description refers to the accompanying drawings that illustrate exemplary embodiments consistent with this invention. Other embodiments are possible, and modifications can be made to the embodiments within the spirit and scope of the invention. Therefore, the detailed description is not meant to limit the invention. Rather, the scope of the invention is defined by the appended claims.

It would be apparent to one of skill in the art that the present invention, as described below, can be implemented in many different embodiments of software, hardware, firmware, and/or the entities illustrated in the figures. Thus, the operational behavior of embodiments of the present invention will be described with the understanding that modifications and variations of the embodiments are possible, given the level of detail presented herein.

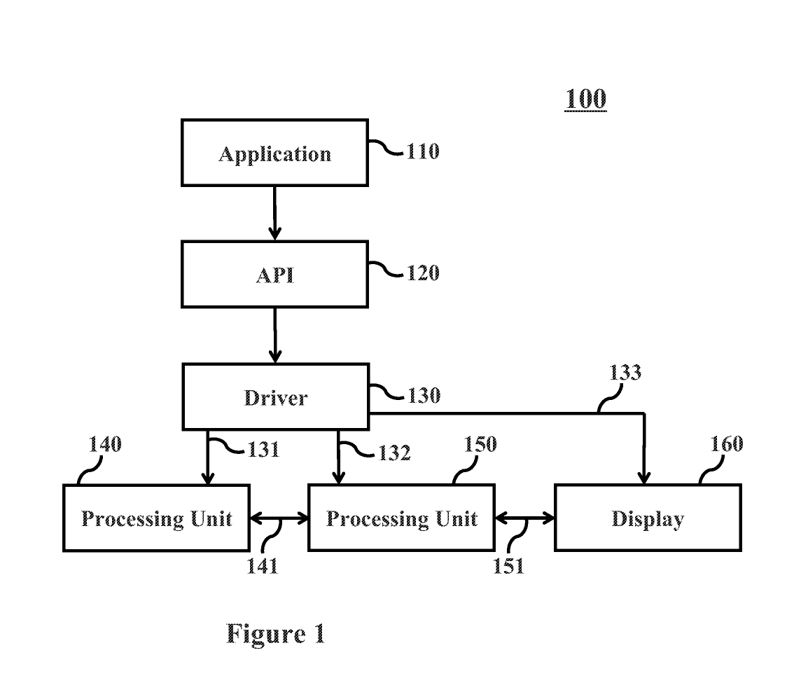

FIG. 1 is an illustration of a multi-processor computing system 100 in which embodiments of the present invention can be implemented. Multi-processor computing system 100 includes an application module 110, an application programming interface (API) 120, a driver module 130, a first processing unit 140, a second processing unit 150, and a display module 160. Application module 110 can be an end-user application that requires graphics processing such as, for example and without limitation, a video game application. API 120 can be device-specific and can be configured to serve as an intermediary between application module 110 and driver module 130, according to an embodiment of the present invention. In particular, API 120 can allow a wide range of common graphics functions to be written by software developers such that the graphics functions operate on many different hardware systems (e.g., processing units 140 and 150). Examples of API 120 include, but are not limited to, DirectX (from Microsoft) and OpenGL (from Khronos).

In an embodiment, each of processing units 140 and 150 can be, for example and without limitation, a central processing unit (CPU), a graphics processing unit (GPU), an application-specific integrated circuit (ASIC) controller, other similar types of processing units, or a combination thereof. Processing units 140 and 150 are configured to execute instructions and to carry out operations associated with multi-processor computing system 100. For instance, multi-processor computing system 100 can be configured to render and display graphics. Multi-processor computing system 100 can include a CPU (e.g., processing unit 140) and a GPU (e.g., processing unit 150), where the GPU can be configured to render two- and three-dimensional graphics, and the CPU can be configured to coordinate the display of the rendered graphics onto display module 160. Display module 160 can be, for example and without limitation, a cathode ray tube display, a liquid crystal display, a light emitting diode display, or other similar types of display devices.

In an embodiment, each of processing units 140 and 150 has an operations profile which may include a performance profile and/or a functionality profile. The performance profile includes performance information on the processing unit such as, for example and without limitation, operating frequency and memory bandwidth. A performance profile for each of processing units 140 and 150 can be determined by a profiler unit (not illustrated in FIG. 1) configured to monitor and/or store the performance of processes/applications running on each of processing units 140 and 150. Such monitoring can be performed once (e.g., upon initialization or fabrication of multi-processor computing system 100) or dynamically, according to an embodiment of the present invention. For instance, in the rendering of display graphics, the profiling unit can determine that processing unit 140 renders graphics data at a higher rate than processing unit 150, which may be due to a higher operating frequency and/or memory bandwidth in processing unit 140 as compared to processing unit 150. In an embodiment, the performance profile information for each of processing units 140 and 150 can be provided to driver module 130 for further processing, as will be described in further detail below. In the alternative, the performance profiles for each of processing units 140 and 150 can be fixed, rather than determined during operation of processing units 140 and 150. In this case, driver module 130 can receive the performance profile information at startup of multi-processor computing system 100 and distribute work accordingly to processing units 140 and 150, as will be described in further detail below. Methods and techniques for gathering data for purposes of performance profiling in processing units are known those persons skilled in the relevant art.

The functionality profile includes functionality information on each of processing units 140 and 150 such as, for example and without limitation, compatibility to a particular API. For instance, processing unit 140 can be compatible with a first API (e.g., the DX11 instruction set) and processing unit 150 can be compatible with a second API (e.g., the DX10 instruction set). As understood by a person skilled in the relevant art, the first and second APIs can have functions that are common to both APIs. Conversely, the first API can have functions unique to its API and, thus, may not be compatible with the second API. In an embodiment, the functionality profile information for each of processing units 140 and 150 can be provided to driver module 130 for further processing, as will be described in further detail below.

Embodiments described herein optimize or improve, in certain cases, the performance and functionality of processing units 140 and 150 in order to improve performance in multi-processor computing system 100. For instance, with respect to multi-processor computing system 100 of FIG. 1, an imbalance may exist in the processing of graphics data frames between processing unit 140 and processing unit 150. This imbalance may be due to various factors such as, for example and without limitation, a mismatch in the performance and functionality of processing units 140 and 150. As described in further detail below, embodiments of the present invention address this imbalance in order to improve performance in multi-processor computing system 100.

With respect to multi-processor computing system 100 of FIG. 1, driver module 130 is a computer program that allows a higher-level graphics computing program, from application module 110, to interact with processing unit 140 and processing unit 150, according to an embodiment of the present invention. For instance, driver module 130 can be written by a manufacturer of processing unit 140 and/or processing unit 150 to translate standard code received from API 120 into a native format understood by processing units 140 and 150. Driver module 130 allows input from, for example and without limitation, application module 110 or a user to direct settings of processing units 140 and 150. Such settings include selection of an anti-aliasing control, a texture filter control, and a mipmap detail control. For example, a user can select one or more of these settings via a user interface (UI), including a UI supplied to the user with graphics processing hardware and software.

In reference to FIG. 1, driver module 130 issues commands to processing unit 140, processing unit 150, and display module 160 via driver outputs 131, 132, and 133, respectively. In an embodiment, driver module 130 receives a graphics operation from application module 110 via API 120. Driver module 130 is configured to allocate a first portion of the graphics operation to processing unit 140 and a second portion of the graphics operation to processing unit 150 based on the performance profile and/or the functionality profile of processing units 140 and 150, according to an embodiment of the present invention.

In an embodiment, driver module 130 coordinates an N:1 alternate frame rendering (AFR) operation between processing unit 140 and processing unit 150. AFR refers to a parallel graphics rendering technique, which can display an output of two or more processing units to a single monitor (e.g., display module 160 of FIG. 1), in order to improve rendering performance. AFR can be used in many graphics applications such as, for example, the generation of sequences of three-dimensional graphics frames in real time.

Based on the performance profiles of processing units 140 and 150, driver module 130 can allocate N times number of graphics data frames to be rendered on one processing unit (e.g., processing unit 140) for every graphics data frame to be rendered on the other processing unit (e.g., processing unit 150). For instance, processing unit 140 can have four times the computational bandwidth or performance as compared to processing unit 150. As such, driver module 130 can issue commands to render four graphics data frames on processing unit 140 for every one graphics data frame rendered on processing unit 150, resulting in a 4:1 AFR operation between processing units 140 and 150.

In referring to FIG. 1, after processing unit 140 renders four graphics data frames, these rendered graphics data frames are transferred to processing unit 150 via output 141. At this point, processing unit 150 has also rendered one graphics data frame. The five graphics data frames rendered by both processing units 140 and 150 are transferred from processing unit 150 to display module 160 via output 151. In an embodiment, driver module 130 coordinates, via control signals on driver output 131, the transfer of rendered graphics data frames from processing unit 140 to processing unit 150. Driver module 130 also coordinates, via control signals on driver output 132, the transfer of rendered graphics data frames from processing unit 150 to display module 160. Further, driver module 130 coordinates, via control signals on driver output 133, the display of the rendered graphics data frames processed by both processing units 140 and 150 onto display module 160. Methods and techniques to transfer rendered graphics data frames from one processing unit to another processing unit, as well as to coordinate the display of rendered graphics data frames on a display module, are known to persons skilled in the relevant art.

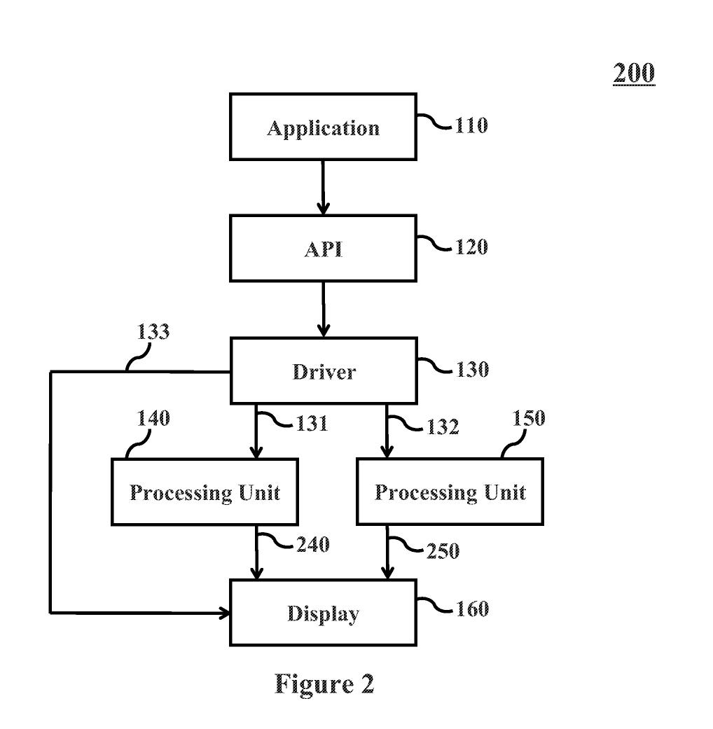

FIG. 2 is an illustration of another multi-processor computing system 200 in which embodiments of the present invention can be implemented. Multi-processor computing system 200 includes application module 110, API 120, driver module 130, first processing unit 140, second processing unit 150, and display module 160. Unlike multi-processor computing system 100 of FIG. 1, in which processing unit 150 is communicatively coupled to display module 160 via driver output 151, processing units 140 and 150 in multi-processor computing system 200 of FIG. 2 are each communicatively coupled to display module 160 via outputs 240 and 250, respectively.

An N:1 AFR operation between processing units 140 and 150 in multi-processor computing system 200 operates in a substantially similar manner as described above with respect to multi-processor computing system 100 of FIG. 1. However, rather than a transfer of rendered graphics data frames being from processing unit 140 to processing unit 150 via output 141 of FIG. 1, rendered graphics data frames from processing units 140 and 150 are transferred to display module 160 via outputs 240 and 250, respectively. In an embodiment, driver module 130 coordinates, via control signals on driver outputs 131 and 132, the transfer of the rendered graphics data frames from processing units 140 and 150 to display module 160. Driver module 130 also coordinates, via control signals on driver output 133, the display of the rendered graphics data frames processed by both processing units 140 and 150 onto display module 160.

A benefit, among others, of allocating N graphics data frames to processing unit 140 for every one graphics data frame allocated to processing unit 150 is that the performance of multi-processor computing system 100 can be optimized despite a mismatch in performance between processing units 140 and 150.

With respect to multi-processor computing system 100 of FIG. 1, driver module 130 coordinates an execution of a first graphics operation to processing unit 140 and an execution of a second graphics operation to processing unit 150 based on the performance and functionality profiles of processing units 140 and 150, according to an embodiment of the present invention. The first graphics operation can be different from the second graphics operation, according to an embodiment of the present invention.

Three situations are considered in this embodiment of the present invention. First, the situation in which processing units 140 and 150 share substantially similar functionality profiles, but have different performance profiles from one another, is considered. Second, the situation in which processing units 140 and 150 have different functionality profiles, but have substantially similar performance profiles to one another, is considered. Third, the situation in which processing units 140 and 150 have different functionality and performance profiles from one another is considered.

First, the situation in which processing units 140 and 150 share substantially similar functionality profiles, but have different performance profiles from one another, is considered in the following discussion. Based on the respective performance profiles of processing units 140 and 150, in an embodiment, driver module 130 can allocate a first graphics operation in a graphics processing pipeline to processing unit 140 and a second graphics operation in the graphics processing pipeline to processing unit 150. For instance, processing unit 140 can have four times the computational bandwidth or performance as compared to processing unit 150. As such, driver module 130 can allocate a graphics operation that requires more computational bandwidth than another graphics operation in the graphics processing pipeline to processing unit 140 and allocate the other graphics operation to processing unit 150.

For instance, as would be understood by a person skilled in the relevant art, 3D rendering (e.g., tessellation, vertex shading, rasterization, pixel shading, depth buffering, blending and anti-aliasing) requires more computational bandwidth than post-processing graphics operations (e.g., tone mapping and motion blur) during the rendering process of graphics data frames. Here, driver module 130 can allocate the 3D rendering operations to processing unit 140 and the post-processing graphics operations to processing unit 150. In reference to multi-processor computing system 100 of FIG. 1, driver module 130 can issue one or more commands to processing unit 140, via driver output 131, to perform the 3D rendering operations and issue one or more commands to processing unit 150, via driver output 132, to perform the post-processing graphics operations on a result from the 3D rendering operation executed by processing unit 140. The result from the 3D rendering graphics operation can be transferred from processing unit 140 to processing unit 150 via output 141.

In particular, in a pipeline manner, processing unit 140 can perform a 3D rendering operation on a set of vertices and transfer a result of the 3D rendering, via output 141, to processing unit 150, according to an embodiment of the present invention. While processing unit 150 performs one or more post-processing graphics operations (e.g., tone mapping and motion blur) on the result of the 3D rendering operation, processing unit 140 performs another 3D rendering operation on another set of vertices. Processing unit 150 transfers, via output 151, the post-processed graphics frame data to display module 160 for display. At substantially the same time or immediately after transfer of the post-processed graphics frame data from processing unit 150 to display module 160, processing unit 150 receives another result of the 3D rendering operation from processing unit 140.

In an embodiment, driver module 130, via control signals on driver outputs 131, 132, and 133, coordinates the transfer of the result of the 3D render operation from processing unit 140 to processing unit 150, as well as the transfer of the post-processed graphics frame data from processing unit 150 to display module 160. In an embodiment, each of processing units 140 and 150 includes a dedicated command memory buffer and a time stamp such that driver module 130 can switch its control from one processing unit to another without a “flush” of a common command memory buffer, which would be required if the command memory buffer were not shared by processing units 140 and 150.

Next, the situation in which processing units 140 and 150 have different functionality profiles, but have substantially similar performance profiles to one another, is considered in the following discussion. Based on the respective functionality profiles of processing units 140 and 150, in an embodiment, driver module 130 can allocate a first graphics operation to processing unit 140 and a second graphics operation to processing unit 150. In an embodiment, processing unit 140 is compatible with a first API (e.g., the DX11 instruction set) and processing unit 150 can be compatible with a second API (e.g., the DX10 instruction set), in which the first API is different from the second API but has one or more functions in common with the second API. For instance, the DX11 instruction set includes all of the features provided by the DX10 instruction set such as, for example and without limitation, stream out, shader model 4.0, and geometry shader functionalities. The DX11 instruction set also includes features not provided by the DX10 instruction set such as, for example and without limitation, tessellation and compute shader functionality, as well as subroutines for shader programs.

For ease of explanation and exemplary purposes, it will be assumed that processing unit 140 is compatible with the DX11 instruction set and that processing unit 150 is compatible with the DX10 instruction set. Although the following discussion is in the context of the DirectX API, a person skilled in the relevant art will recognize that other API platforms can be used with the embodiments described herein such as, for example and without limitation, the OpenGL API.

Since processing unit 140 is compatible with the DX11 instruction set, processing unit 140 can execute graphics operations that are common to both the DX10 and DX11 instruction sets, as well as graphics operations that are unique to the DX11 instruction set. On the other hand, processing unit 150 can only execute graphics operations that are part of the DX10 instruction set. In an embodiment, driver module 130 parses a sequence of commands from the DX11 API in order to identify commands that are common between the DX10 and DX11 APIs such that these common commands can be executed by processing unit 150 (e.g., the processing unit compatible with the DX10 API). For the commands that are not common between the DX10 and DX11 APIs, driver module 130 sends these commands to processing unit 140 (e.g., the processing unit compatible with the DX11 API).

In an embodiment, driver module 130, via control signals on driver outputs 131, 132, and 133, coordinates the transfer of the output of processing unit 140 to either processing unit 150 or to display module 160. For instance, the output of processing unit 140 may need to be further processed by a graphics operation executed on processing unit 150. In this case, driver module 130 coordinates the transfer of the output of processing unit 140 to processing unit 150 via output 141. If the output of processing unit 140 is ready for display on display module 160, then driver module 130 coordinates the transfer of the output of processing unit 140 to display module 160. Driver module 130 coordinates the transfer of the output of processing unit 150 to either processing unit 140 or display module 160 in substantially the same manner as described above.

Lastly, the situation in which processing units 140 and 150 have different performance and functionality profiles from one another is considered in the following discussion. Based on the respective performance and functionality profiles of processing units 140 and 150, in an embodiment, driver module 130 can allocate a first graphics operation to processing unit 140 and a second graphics operation to processing unit 150. The example discussed above will be used in the explanation of this embodiment of the present invention. In particular, it will be assumed that processing unit 140 is compatible with the DX11 instruction set and that processing unit 150 is compatible with the DX10 instruction set.

Similar to the discussion above, processing unit 140 can execute graphics operations that are common to both the DX10 and DX11 instruction sets, as well as graphics operations that are unique to the DX11 instruction set. Processing unit 150 can only execute graphics operations that are common to both the DX10 and DX11 instruction sets. Based on the respective performance profiles of processing units 140 and 150, in an embodiment, driver module 130 can allocate one or more graphics operations that are common to both the DX10 and DX11 instruction sets, as well as the graphics operations that are unique to the DX11 instruction set, to processing unit 140. For instance, processing unit 140 can have four times the computational bandwidth or performance as compared to processing unit 150. As such, driver module 130 can allocate a higher number of graphics operations to processing unit 140 than the number of graphics operations allocated to processing unit 150.

In particular, due to the high computational bandwidth of processing unit 140 as compared to processing unit 150, driver module 130 can allocate stream out and geometry shader graphics operations to processing unit 140, as well as graphics operations unique to the DX11 API (e.g., tessellation and compute shader functionality and subroutines for shader programs). As noted above, the stream out and geometry shader graphics operations are graphics operations common to both the DX10 and DX11 APIs. In an embodiment, a profiler unit (not illustrated in FIG. 1) can be used to monitor the performance of graphics operations/applications running on each of processing units 140 and 150 to help assess an optimal set of graphics operations common to both the DX10 and DX11 APIs that can be executed on processing unit 140. As a result, the performance and functionality of processing units 140 and 150 can be optimized in multi-processor computing system 100 of FIG. 1.

A goal, among others, of allocating the execution of a first graphics operation to processing unit 140 and the execution of a second graphics operation to processing unit 150 based on the performance and functionality profiles of processing units 140 and 150 is improvement in the performance of multi-processor computing system 100 of FIG. 1. For instance, a mismatch in performance and functionality can exist between processing units 140 and 150. The embodiments described herein provide a solution to optimize the performance of multi-processor computing system 100 despite this mismatch.

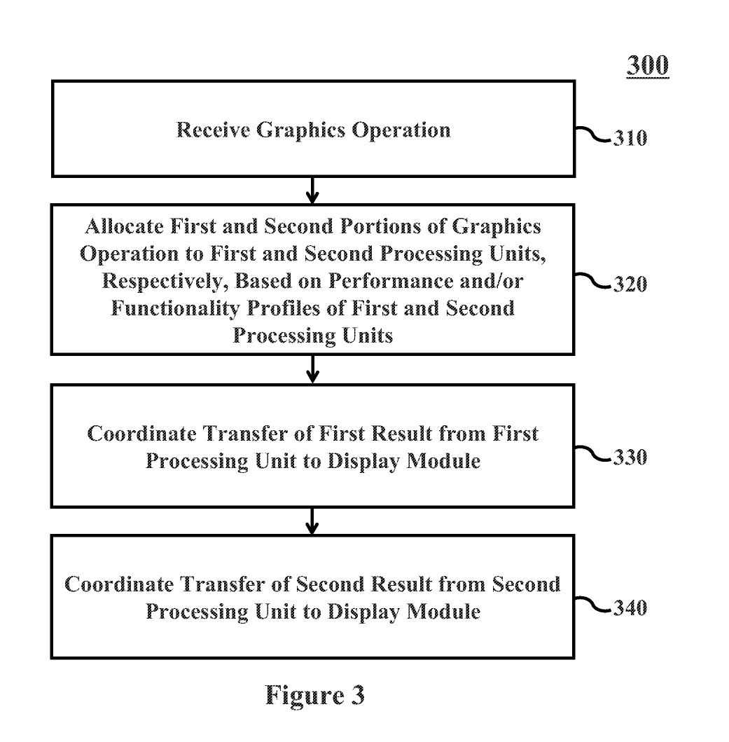

FIG. 3 is an illustration of an embodiment of a method 300 for processing one or more graphics operations. Method 300 can occur using, for example and without limitation, multi-processor computing system 100 of FIG. 1 or multi-processor computing system 200 of FIG. 2.

In step 310, a driver module receives one or more graphics commands from an application. In an embodiment, an API serves as an intermediary between the driver module and the application, in which the API provides the one or more graphics commands to the driver module.

In step 320, the driver module allocates a first portion of the graphics operation to a first processing unit and a second portion of the graphics operation to a second processing unit based on at least one of a performance profile and a functionality profile of each of the first and second processing units.

In an embodiment, the graphics operation of step 320 is an N:1 AFR operation between the first and second processing units. The first processing unit can render N number of graphics data frames for every graphics data frame rendered on the second processing unit. Here, the N:1 ratio of rendered graphics data frames can be based on a comparison of a computational bandwidth of the first processing unit to a computational bandwidth of the second processing unit.

In another embodiment, the first portion of the graphics operation is a 3D rendering operation and the second portion of the graphics operation is a post-processing graphics operation. The first processing unit also has a higher computational bandwidth than the second processing unit, and is thus allocated the 3D rendering operation. Typically, 3D rendering (e.g., tessellation, vertex shading, rasterization, pixel shading, depth buffering, blending and anti-aliasing) are more computationally intensive than post-processing graphics operations (e.g., tone mapping and motion blur).

In yet another embodiment, the first processing unit is compatible with a first API and the second processor is compatible with a second API (that is different from the first API). The first portion of the graphics operation is one or more graphics operations associated with the first API. Similarly, the second portion of the graphics operation is one or more graphics operations associated with the second API.

In an embodiment, if the first and second processing units have different performance profiles from one another, then one or more graphics operations associated with the first API and one or more graphics operations common to both the first and second APIs are allocated to the first portion of the graphics operation to be executed by the first processing unit. The one or more graphics operations associated with the second API is allocated to the second portion of the graphics operation to be executed by the second processing unit.

In step 330, the driver module coordinates a transfer of a first result from the first processing unit to a display module. In an embodiment, the driver module can transfer the first result of the first processing unit to the display module in substantially the same manner as described above with respect to FIGS. 1 and 2.

In step 340, the driver module coordinates a transfer of a second result from the second processing unit to the display module. In an embodiment, the driver module can transfer the second result of the second processing unit to the display module in substantially the same manner as described above with respect to FIGS. 1 and 2.

In an alternative embodiment, the first and second processing units can be functionally different from one another. In this case, rendering, for example, can be performed on one of the processing units and post processing can be performed on the other. Only data from one of the processing units will be sent to the display module.

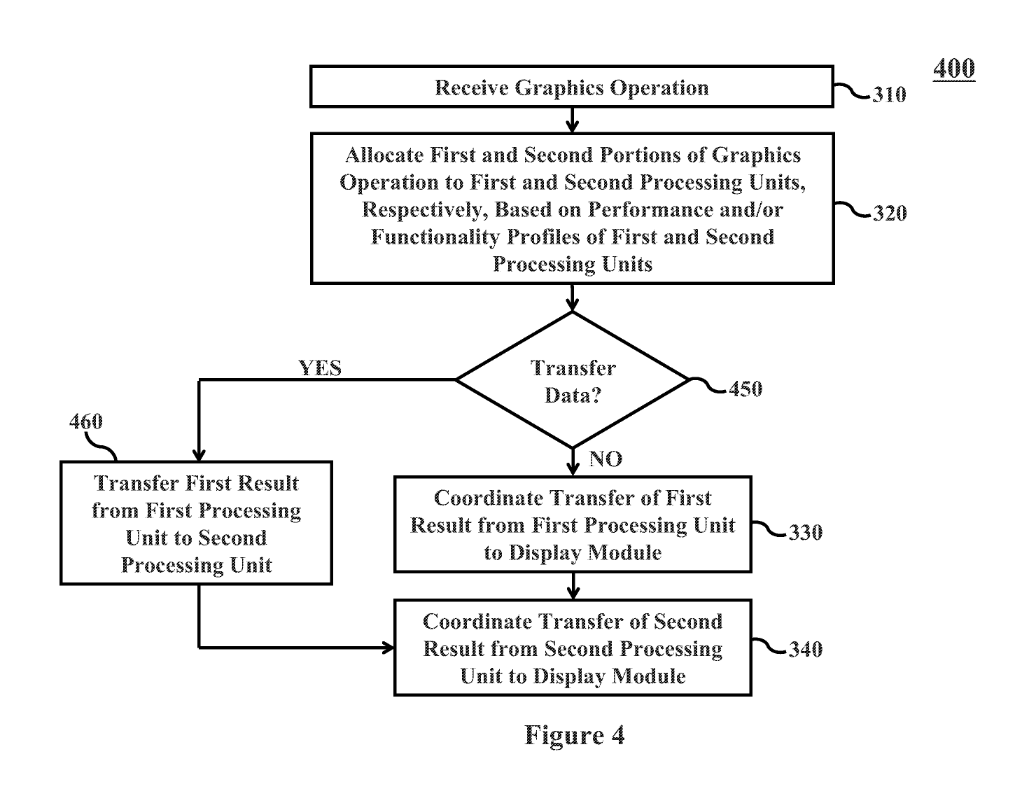

FIG. 4 is an illustration of another method 400 for processing one or more graphics operations in which method 400 provides an option for data from one of the processing units to be transferred to the other processing unit for further processing.

With respect to FIG. 4, steps 310-340 are performed in the same manner as described above with respect to method 300 of FIG. 3. In step 450, if a first result from the first processing unit needs to be transferred to the second processing unit in order to complete the graphics operation, then this transfer is performed in step 460. Otherwise, if the first result does not need to be transferred to the second processing unit, then method 400 proceeds to step 330.

In step 460, the second processing unit receives the first result from the first processing unit. The first processing unit can have a higher computational bandwidth than the second processing unit, and can be allocated a computationally-intensive operation such as, for example, a 3D rendering operation (e.g., tessellation, vertex shading, rasterization, pixel shading, depth buffering, blending and anti-aliasing). The second processing unit can be allocated a less computationally-intensive operation than the operation allocated to the first processing unit such as, for example, a post-processing graphics operation (e.g., tone mapping and motion blur). In an embodiment, the second processing unit receives a result of the 3D rendering operation (e.g., first result from the first processing unit) and performs the post-processing graphics operation on the result. Once the post-processing operation is complete, the second processing unit can transfer the result of the graphics operation (e.g., second result from the second processing unit) to the display module in step 340.

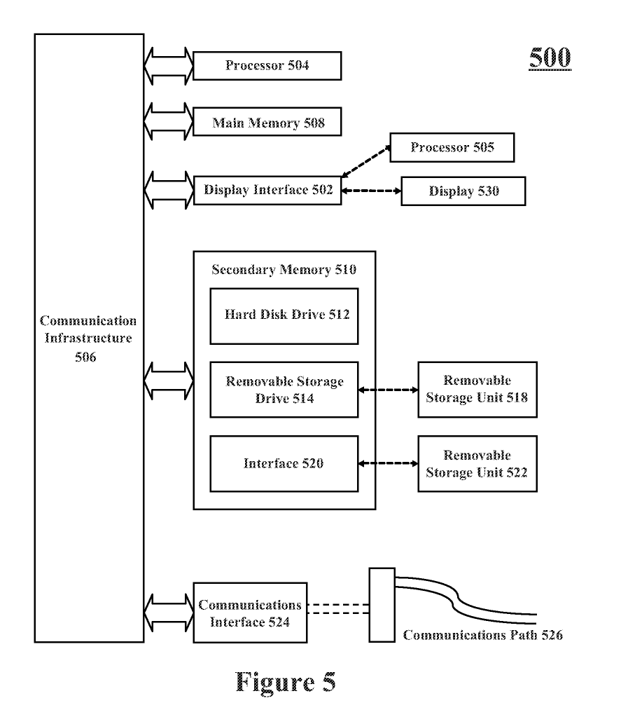

Various aspects of the present invention may be implemented in software, firmware, hardware, or a combination thereof. FIG. 5 is an illustration of an example computer system 500 in which embodiments of the present invention, or portions thereof, can be implemented as computer-readable code. For example, the methods illustrated by flowchart 300 of FIG. 3 and flowchart 400 of FIG. 4 can be implemented in system 500. Various embodiments of the present invention are described in terms of this example computer system 500. After reading this description, it will become apparent to a person skilled in the relevant art how to implement embodiments of the present invention using other computer systems and/or computer architectures.

It should be noted that the simulation, synthesis and/or manufacture of various embodiments of this invention may be accomplished, in part, through the use of computer readable code, including general programming languages (such as C or C++), hardware description languages (HDL) such as, for example, Verilog HDL, VHDL, Altera HDL (AHDL), or other available programming and/or schematic capture tools (such as circuit capture tools). This computer readable code can be disposed in any known computer-usable medium including a semiconductor, magnetic disk, optical disk (such as CD-ROM, DVD-ROM). As such, the code can be transmitted over communication networks including the Internet. It is understood that the functions accomplished and/or structure provided by the systems and techniques described above can be represented in a core (such as a GPU core) that is embodied in program code and can be transformed to hardware as part of the production of integrated circuits.

Computer system 500 includes one or more processors, such as processors 504 and 505. Processor 504 may be a special purpose or a general purpose processor. Processor 504 is connected to a communication infrastructure 506 (e.g., a bus or network). Processor 505, for example, can be a GPU. In particular, processor 505 can be used to process graphics on a display module 530, in which processor 505 communicates with a display interface 502 to process and display graphics on display module 530.

Computer system 500 also includes a main memory 508, preferably random access memory (RAM), and may also include a secondary memory 510. Secondary memory 510 can include, for example, a hard disk drive 512, a removable storage drive 514, and/or a memory stick. Removable storage drive 514 can include a floppy disk drive, a magnetic tape drive, an optical disk drive, a flash memory, or the like. The removable storage drive 514 reads from and/or writes to a removable storage unit 518 in a well known manner. Removable storage unit 518 can comprise a floppy disk, magnetic tape, optical disk, etc. which is read by and written to by removable storage drive 514. As will be appreciated by persons skilled in the relevant art, removable storage unit 518 includes a computer-usable storage medium having stored therein computer software and/or data.

In alternative implementations, secondary memory 510 can include other similar devices for allowing computer programs or other instructions to be loaded into computer system 500. Such devices can include, for example, a removable storage unit 522 and an interface 520. Examples of such devices can include a program cartridge and cartridge interface (such as those found in video game devices), a removable memory chip (e.g., EPROM or PROM) and associated socket, and other removable storage units 522 and interfaces 520 which allow software and data to be transferred from the removable storage unit 522 to computer system 500.

Computer system 500 can also include a communications interface 524. Communications interface 524 allows software and data to be transferred between computer system 500 and external devices. Communications interface 524 can include a modem, a network interface (such as an Ethernet card), a communications port, a PCMCIA slot and card, or the like. Software and data transferred via communications interface 524 are in the form of signals which may be electronic, electromagnetic, optical, or other signals capable of being received by communications interface 524. These signals are provided to communications interface 524 via a communications path 526. Communications path 526 carries signals and can be implemented using wire or cable, fiber optics, a phone line, a cellular phone link, a RF link or other communications channels.

In this document, the terms “computer program medium” and “computer-usable medium” are used to generally refer to media such as removable storage unit 518, removable storage unit 522, and a hard disk installed in hard disk drive 512. Computer program medium and computer-usable medium can also refer to memories, such as main memory 508 and secondary memory 510, which can be memory semiconductors (e.g., DRAMs, etc.). These computer program products provide software to computer system 500.

Computer programs (also called computer control logic) are stored in main memory 508 and/or secondary memory 510. Computer programs may also be received via communications interface 524. Such computer programs, when executed, enable computer system 500 to implement embodiments of the present invention as discussed herein. In particular, the computer programs, when executed, enable processor 504 to implement processes of embodiments of the present invention, such as the steps in the methods illustrated by flowchart 300 of FIG. 3 and flowchart 400 of FIG. 4, discussed above. Accordingly, such computer programs represent controllers of the computer system 500. Where embodiments of the present invention are implemented using software, the software can be stored in a computer program product and loaded into computer system 500 using removable storage drive 514, interface 520, hard drive 512, or communications interface 524.

Embodiments of the present invention are also directed to computer program products including software stored on any computer-usable medium. Such software, when executed in one or more data processing device, causes a data processing device(s) to operate as described herein. Embodiments of the present invention employ any computer-usable or -readable medium, known now or in the future. Examples of computer-usable mediums include, but are not limited to, primary storage devices (e.g., any type of random access memory), secondary storage devices (e.g., hard drives, floppy disks, CD ROMS, ZIP disks, tapes, magnetic storage devices, optical storage devices, MEMS, nanotechnological storage devices, etc.), and communication mediums (e.g., wired and wireless communications networks, local area networks, wide area networks, intranets, etc.).

While various embodiments of the present invention have been described above, it should be understood that they have been presented by way of example only, and not limitation. It will be understood by persons skilled in the relevant art that various changes in form and details can be made therein without departing from the spirit and scope of the invention as defined in the appended claims. It should be understood that the invention is not limited to these examples. The invention is applicable to any elements operating as described herein. Accordingly, the breadth and scope of the present invention should not be limited by any of the above-described exemplary embodiments, but should be defined only in accordance with the following claims and their equivalents.

What is claimed is:

1. A method for processing a graphics operation, the method comprising:
allocating a first portion of graphics operations to a first processing unit and a second portion of the graphics operations to a second processing unit based on at least one of a performance profile and a functionality profile of each of the first and second processing units.

2. The method of claim 1, further comprising:
coordinating a transfer of a first result from the first processing unit to a display module; and
coordinating a transfer of a second result from the second processing unit to the display module.

3. The method of claim 1, wherein the allocating the first portion and the second portion comprises:
coordinating a rendering of N number of graphics data frames on the first processing unit for every graphics data frame rendered on the second processing unit.

4. The method of claim 3, wherein the rendering of the N number of graphics data frames comprises selecting an N:1 ratio of rendered graphics data frames based on a comparison of a computational bandwidth of the first processing unit to a computational bandwidth of the second processing unit.

5. The method of claim 1, wherein the allocating the first portion and the second portion comprises:
allocating a geometry-related graphics operation to the first processing unit; and
allocating a post-processing graphics operation to the second processing unit, wherein the first processing unit has a higher computational bandwidth than the second processing unit.

6. The method of claim 1, wherein the first processing unit is compatible with a first application programming interface (API) and the second processing unit is compatible with a second API different from the first API, and wherein the allocating the first portion and the second portion comprises:
allocating one or more graphics operations associated with the first API to the first processing unit; and
allocating one or more graphics operations associated with the second API to the second processing unit.

7. The method of claim 1, wherein the first processing unit is compatible with a first application programming interface (API) and the second processing unit is compatible with a second API different from the first API, and wherein the allocating the first portion and the second portion comprises:
allocating one or more graphics operations associated with the first API and one or more graphics operations common to both the first and second APIs to the first processing unit; and
allocating one or more graphics operations associated with the second API to the second processing unit.

8. A computer program product comprising a computer-usable medium having computer program logic recorded thereon that, when executed by one or more processors, processes a graphics operation, the computer program logic comprising:
first computer readable program code that enables a processor to allocate a first portion of graphics operations to a first processing unit and a second portion of graphics operations to a second processing unit based on at least one of a performance profile and a functionality profile of each of the first and second processing units.

9. The computer program product of claim 8, wherein the computer program logic further comprises:
second computer readable program code that enables a processor to coordinate a transfer of a first result from the first processing unit to a display module; and
third computer readable program code that enables a processor to coordinate a transfer of a second result from the second processing unit to the display module.

10. The computer program product of claim 8, wherein the first computer readable program code comprises:
second computer readable program code that enables a processor to coordinate a rendering of N number of graphics data frames on the first processing unit for every graphics data frame rendered on the second processing unit.

11. The computer program product of claim 10, wherein the second computer readable program code comprises:
third computer readable program code that enables a processor to select an N:1 ratio of rendered graphics data frames based on a comparison of a computational bandwidth of the first processing unit to a computational bandwidth of the second processing unit.

12. The computer program product of claim 8, wherein the first computer readable program code comprises:
second computer readable program code that enables a processor to allocate a geometry-related graphics operation to the first processing unit; and
third computer readable program code that enables a processor to allocate a post-processing graphics operation to the second processing unit, wherein the first processing unit has a higher computational bandwidth than the second processing unit.

13. The computer program product of claim 8, wherein the first processing unit is compatible with a first application programming interface (API) and the second processing unit is compatible with a second API different from the first API, and wherein the first computer readable program code comprises:
second computer readable program code that enables a processor to allocate one or more graphics operations associated with the first API to the first processing unit; and
third computer readable program code that enables a processor to allocate one or more graphics operations associated with the second API to the second processing unit.

14. The computer program product of claim 8, wherein the first processing unit is compatible with a first application programming interface (API) and the second processing unit is compatible with a second API different from the first API, and wherein the first computer readable program code comprises:
second computer readable program code that enables a processor to allocate one or more graphics operations associated with the first API and one or more graphics operations common to both the first and second APIs to the first processing unit; and
third computer readable program code that enables a processor to allocate one or more graphics operations associated with the second API to the second processing unit.

15. A computing system, comprising:
an application module;
an application programming interface (API);
a first processing unit;
a second processing unit;
a driver module configured to allocate a first portion of graphics operations to the first processing unit and a second portion of graphics operations to the second processing unit based on at least one of a performance profile and a functionality profile of each of the first and second processing units; and
a display module.

16. The computing system of claim 15, wherein the driver module is configured to:
coordinate a transfer of a first result from the first processing unit to the display module; and
coordinate a transfer of a second result from the second processing unit to the display module.

17. The computing system of claim 15, wherein the driver module is configured to coordinate a rendering of N number of graphics data frames on the first processing unit for every graphics data frame rendered on the second processing unit.

18. The computing system of claim 17, wherein the driver module is configured to select an N:1 ratio of rendered graphics data frames based on a comparison of a computational bandwidth of the first processing unit to a computational bandwidth of the second processing unit.

19. The computing system of claim 15, wherein the driver module is configured to:
allocate a geometry-related graphics operation to the first processing unit; and
allocate a post-processing graphics operation to the second processing unit, wherein the first processing unit has a higher computational bandwidth than the second processing unit.

20. The computing system of claim 15, wherein the first processing unit is compatible with the API and the second processing unit is compatible with another API different from the API.

21. The computing system of claim 20, wherein the driver module is configured to:
allocate one or more graphics operations associated with the API to the first processing unit; and
allocate one or more graphics operations associated with the another API to the second processing unit.

22. The computing system of claim 20, wherein the driver module is configured to:
allocate one or more graphics operations associated with the API and one or more graphics operations common to both the API and the another API to the first processing unit; and
allocate one or more graphics operations associated with the another API to the second processing unit.
